(19) United States
(12) Patent Application Publication
(10) Pub. No.: US 2007/0251035 A1
(43) Pub. Date: Nov. 1, 2007

(54) Cleaning device

(75) Inventors: Wen-Chang Peng, Tainan (TW); Ming-Da Guo, Tainan (TW); Chyi-Shyung Chern, Taipei (TW); Chang-Jung Wu, Tainan (TW)

Correspondence Address: BIRCH, STEWART, KOLASCH & BIRCH, LLP, PO BOX 747, 8110 GATEHOUSE RD, STE 500 EAST, FALLS CHURCH, VA, 22040-0747, US

(73) Assignee: TAIWAN SEMICONDUCTOR MANUFACTURING CO., LTD.

(21) Appl. No.: 11/414,234

(22) Filed: May 1, 2006

(51) Int. Cl. B08B 1/00

(52) U.S. Cl. 15/77; 15/88.2

(57) ABSTRACT

A cleaning device. The cleaning device, for cleaning a brush of a wafer scrubber, includes a cup and a dummy pad. The dummy pad is disposed in the cup. The brush rubs against the dummy pad. A method of cleaning a brush of a wafer scrubber, comprising providing a cup with a dummy pad disposed in the cup, and rubbing the brush against the dummy pad.

### BACKGROUND OF THE INVENTION

1. Field of the Invention

The invention relates to a cleaning device, and in particular, to a cleaning device for cleaning a brush of a wafer scrubber.

2. Description of the Related Art

During surface preparation in semiconductor manufacturing, wafers undergo a cleaning procedure to remove foreign particles or contamination (organic or inorganic). A wafer scrubber comprises a brush scrubbing wafer surfaces, which must be kept clean.

A conventional wafer scrubber 10, shown in FIG. 1, comprises a base 11, a scrubbing portion 12, a bath 13, and a rinse cup 14. The scrubbing portion 12, the bath 13 and the rinse cup 14 are disposed on the base 11. The scrubbing portion 12 comprises a brush 121 and a body 122, wherein the brush 121 is disposed on the body 122. The body 122 rotates around an axle A, moving the brush 121 between a first position and a second position. A wafer W is placed within the bath 13. When the brush 121 is in the first position, the brush 121 rotates to scrub the wafer W. When the brush 121 is in the second position, the brush 121 idles with a small amount of water in the rinse cup 14 to remove particles accumulated on the brush 121.

A scrubbing assembly for a wafer cleaning device exemplifies an improved method to clean the brush. Referring to FIG. 2, a scrubbing assembly comprises a scrubber 20, a cup 21, and an oscillator 22. The cup 21 is filled with DI water. The oscillator 22 is disposed on the cup 21, such that the oscillator 22 vibrates the DI water when the scrubber 20 is in the cup 21, and is in contact with the DI water. Thus, particles adhering to the scrubber 20 are removed.

A cleaning device with an additional oscillator rearranges the disposition of the fixed components for improved particle removal. However, adding an oscillator requires adjustment of the height of the cup and increases fabrication costs.

### BRIEF SUMMARY OF THE INVENTION

The invention provides a cleaning device, for cleaning a brush of a wafer scrubber, comprising a cup and a dummy pad. The dummy pad is disposed in the cup. The brush rubs against the dummy pad.

The dummy pad comprises a plurality of protrusions, integrally formed thereon.

The cleaning device further comprises an inflow pipe, connected to the cup, continuously delivering water to the dummy pad.

The cleaning device further comprises an outflow pipe, connected to the cup, removing water from the cup.

Water is deionized.

The dummy pad has a water drain.

The dummy pad has a rough surface, and the brush rubs against the rough surface.

The invention provides a wafer scrubber, comprising a brush, a cup, and a dummy pad. The brush operates in scrubbing mode and cleaning mode. The dummy pad is disposed in the cup. In scrubbing mode, the brush scrubs the wafer, and in cleaning mode, the brush rubs against the dummy pad.

The brush rotates on the dummy pad during the cleaning mode.

The wafer scrubber further comprises a first water pipe, connected with the scrubber, selectively delivering water to the brush during scrubbing mode.

The wafer scrubber further comprises a second water pipe, connected with the cup, selectively delivering water to the brush during cleaning mode.

The invention also provides a method of cleaning a brush of a wafer scrubber. The method comprises providing a cup with a dummy pad disposed therein, and rubbing the brush against the dummy pad.

The brush rubs against the dummy pad in a rotating manner.

The dummy pad comprises a plurality of protrusions, formed on the dummy pad, against which the brush rubs when rubbing the brush against the dummy pad.

The method further comprises delivering water to the dummy pad, and removing water from the cup.

The dummy pad has a rough surface, against which the brush rubs when rubbing the brush against the dummy pad.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of a conventional wafer scrubber;

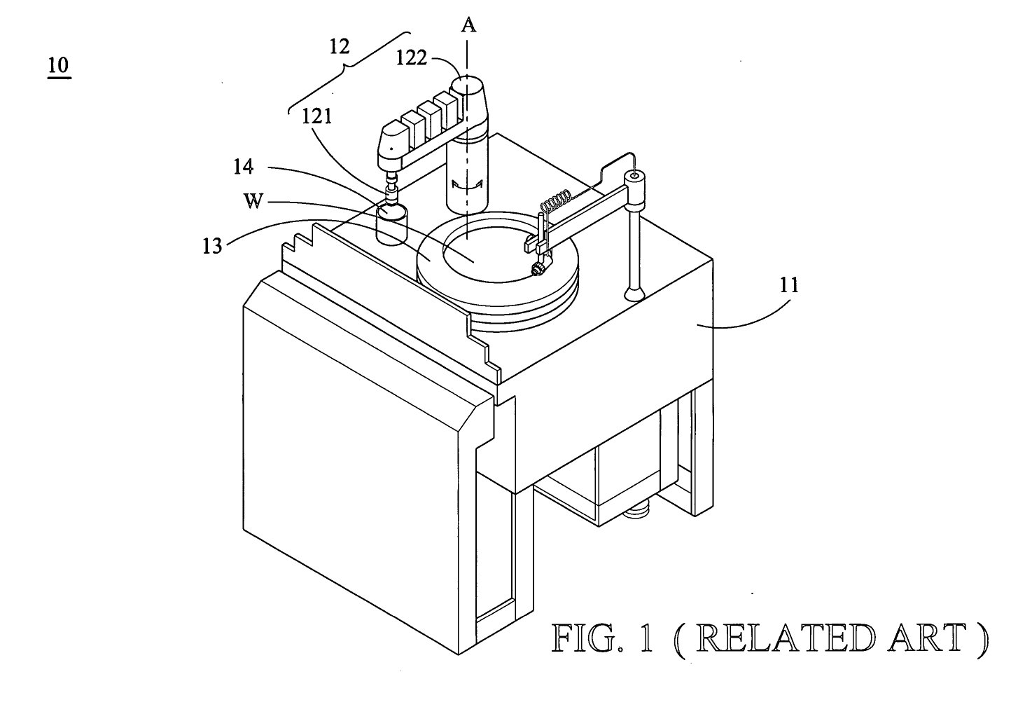

FIG. 2 is a schematic view of a cup, an oscillator and a scrubber of a conventional scrubbing assembly;

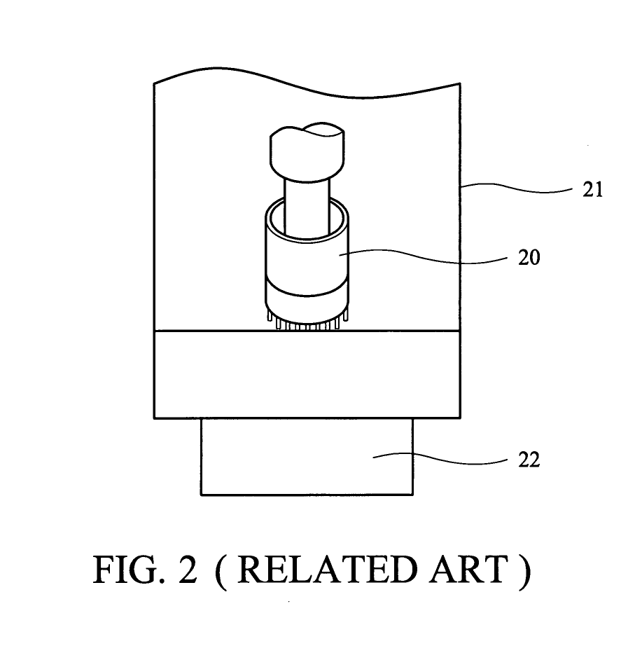

FIG. 3A is a schematic view of a wafer scrubber of an embodiment of the invention;

FIG. 3B is a schematic view of a cup and a dummy pad of the embodiment of the invention; and

FIG. 3C is a top view of a cup and a dummy pad of the embodiment of the invention.

### DETAILED DESCRIPTION OF THE INVENTION

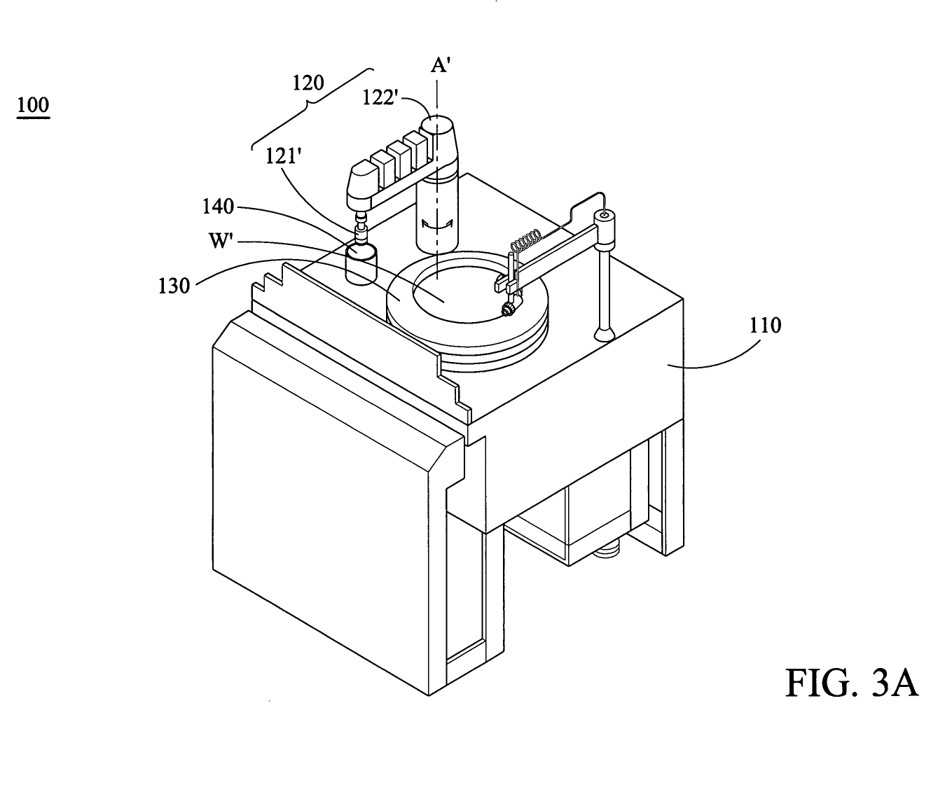

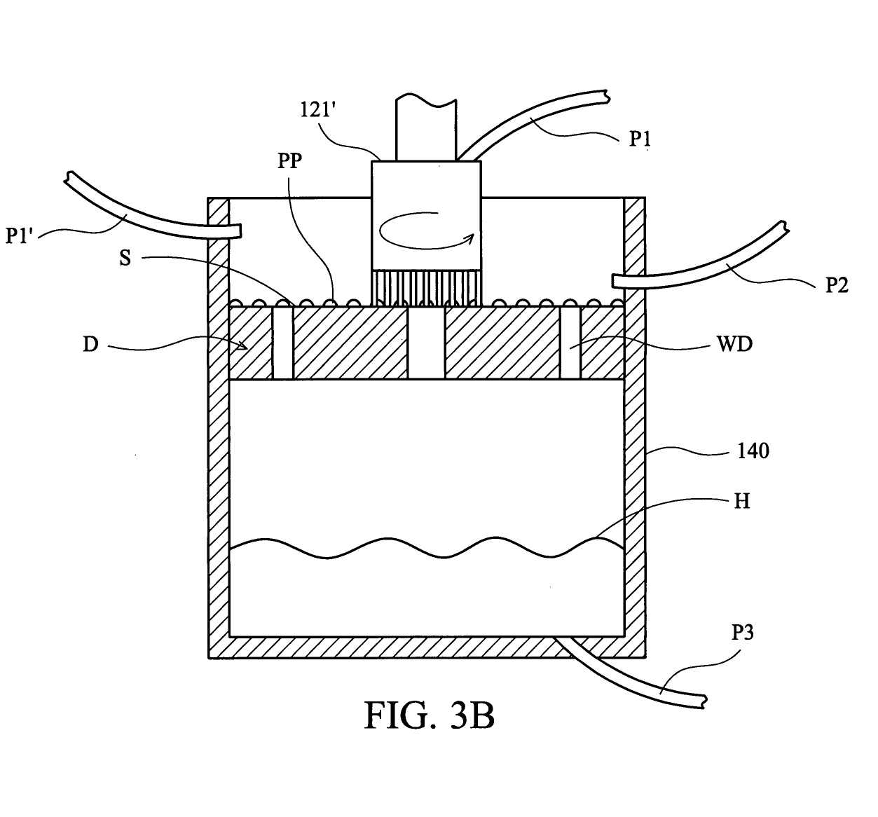

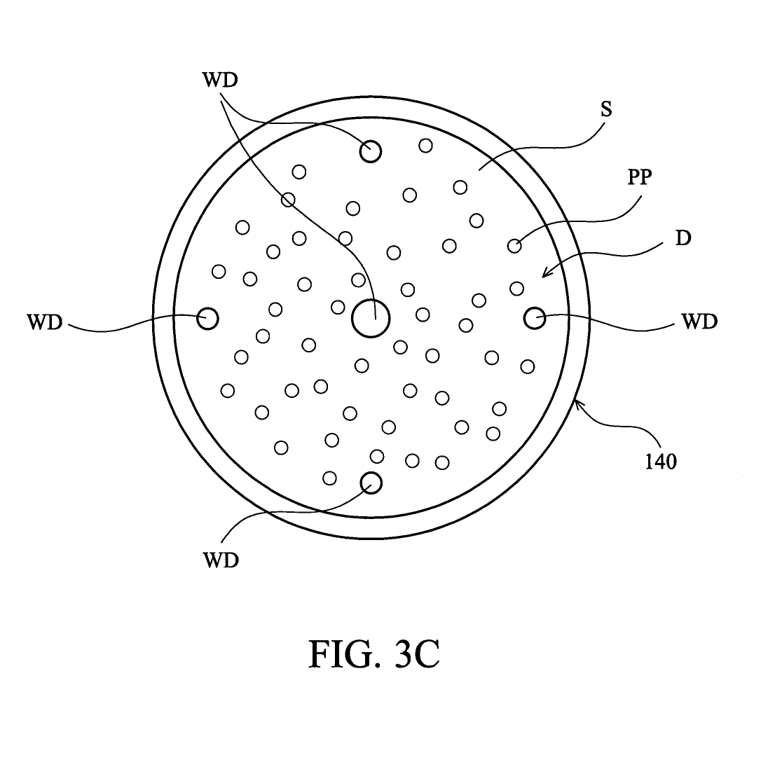

Referring to FIG. 3A, the embodiment provides a wafer scrubber 100, comprising a base 110, a scrubbing portion 120, a bath 130, and a cup 140, wherein the scrubbing portion 120, the bath 130 and the cup 140 are disposed on the base 110.

The scrubbing portion 120 comprises a brush 121′ and a body 122′, wherein the brush 121′ is disposed on the body 122′. The body 122 rotates around an axle A′, moving the brush 121′ between the bath 130 and the cup 140. A wafer W′ is placed within the bath 130.

As shown in FIG. 3B, the wafer scrubber 100 further comprises a dummy pad D, a first water pipe P1, a second water pipe P1′, an inflow pipe P2 and an outflow pipe P3. The dummy pad D is disposed in the cup 140, wherein the dummy pad D and the cup 140 form a cleaning device of the wafer scrubber 100. The dummy pad D has a rough surface S, formed by a plurality of protrusions PP, and five water drains WD (referring to FIG. 3C). It should be noted that the number of the water drains WD of the embodiment is five, but it is not limited thereto.

The first water pipe P1 connects with the brush 121′, selectively providing water to the brush 121′. The second water pipe P1′ connects with the cup 140, selectively providing water to the brush 121′. The inflow pipe P2 connects with the cup 140, continuously providing water to the dummy pad D. The outflow pipe P3 connects with the bottom of the cup 140, removing water stored in the cup 140. It is noted that water mentioned in this system is deionized, but it is not limited thereto.

The brush 121′ is in scrubbing mode and cleaning mode. During scrubbing mode, the brush 121′ moves to the bath 130, and scrubs the wafer W′. The first water pipe P1 delivers water to the brush 121′ when scrubbing the wafer W′. During cleaning mode, the first water pipe P1 stop delivering water; the brush 121′ moves to the cup 140, and rubs against the dummy pad D by self-rotation. In other words, the brush 121′ rotates on the dummy pad D. The second water pipe P1′ delivers water to the brush 121′ and the inflow pipe P2 delivers water to the dummy pad D, rinsing the brush 121′ and the dummy pad D. Used water drains to the bottom of the cup 140 through the water drains WD, and into the outflow pipe P3.

It should be noted that the first water pipe P1 and the second water pipe P1′ selectively deliver water when the brush 121′ is in two different modes. The inflow pipe P2 delivers water when the brush 121′ is in cleaning mode to rinse the brush 121′, and delivers water when the brush 121′ is in scrubbing mode to clean the dummy pad D.

Experimental results of a brush cleaned with and without a dummy pad are shown in a chart as follows. A brush, which has been used for 3000 minutes, rotates on the dummy pad to gain a better particle-removal rate of 99.70%. Compared to conventional methods (brushes idling in the cup), the brush cleaned with a dummy pad achieves a much better result.

| | Brush | Particle | Particles | Particles |
|---|---|---|---|---|
| | condition | removal | remain | remain on the |
| | (min) | rate (%) | on brush | 25^{th} wafer |
| Idles in the cup | 0 (new) | 95.66 | 76ea | 5ea |
| | 2000 | 98.37 | 336ea | >25ea |
| Rotates on the | 3000 | 99.70 | 44ea | 3ea |
| dummy pad | | | | |

The brush 121′ of the embodiment is cleansed by self-rotating on a dummy pad D. Particles are easily removed without making changes to the wafer scrubber 100. Not only is particle-removal rate improved, but economic efficiency is achieved.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A cleaning device, for cleaning a brush of a wafer scrubber, comprising:
a cup; and
a dummy pad, disposed in the cup;
wherein the brush rubs against the dummy pad.

2. The cleaning device as claimed in claim 1, wherein the dummy pad comprises a plurality of protrusions, integrally formed on the dummy pad.

3. The cleaning device as claimed in claim 1, further comprising an inflow pipe, connected to the cup, continuously delivering water to the dummy pad.

4. The cleaning device as claimed in claim 3, further comprising an outflow pipe, connected to the cup, removing water from the cup.

5. The cleaning device as claimed in claim 3, wherein water is deionized.

6. The cleaning device as claimed in claim 1, wherein the dummy pad has a water drain.

7. The cleaning device as claimed in claim 1, wherein the dummy pad has a rough surface, and the brush rubs against the rough surface.

8. A wafer scrubber, comprising:
a brush, operating in scrubbing mode and a cleaning mode;
a cup; and
a dummy pad, disposed in the cup;
wherein in the scrubbing mode, the brush scrubs the wafer, and in the cleaning mode, the brush rubs against the dummy pad.

9. The wafer scrubber as claimed in claim 8, wherein the dummy pad comprises a plurality of protrusions, integrally formed on the dummy pad.

10. The wafer scrubber as claimed in claim 8, further comprising an inflow pipe, connected to the cup, continuously delivering water to the dummy pad.

11. The wafer scrubber as claimed in claim 10, further comprising an outflow pipe, connected to the cup, removing water from the cup.

12. The cleaning device as claimed in claim 10, wherein water is deionized.

13. The wafer scrubber as claimed in claim 8, wherein the dummy pad has a water drain.

14. The wafer scrubber as claimed in claim 8, wherein the brush rotates on the dummy pad during the cleaning mode.

15. The wafer scrubber as claimed in claim 8, further comprising a first water pipe, connected with the brush, selectively delivering water to the brush during the scrubbing mode.

16. The wafer scrubber as claimed in claim 8, further comprising a second water pipe, connected with the cup, selectively delivering water to the brush during the cleaning mode.

17. The wafer scrubber as claimed in claim 8, wherein the dummy pad has a rough surface, against which the brush rubs.
